(19) United States
(12) Patent Application Publication
(10) Pub. No.: US 2016/0111743 A1
(43) Pub. Date: Apr. 21, 2016

(54) METHOD OF GENERATING POWER

(71) Applicant: Caterpillar Inc., Peoria, IL (US)

(72) Inventor: John J. Votoupal, Hudson, IL (US)

(73) Assignee: Caterpillar Inc., Peoria, IL (US)

(21) Appl. No.: 14/982,102

(22) Filed: Dec. 29, 2015

(51) Int. Cl. H01M 8/06; H01M 12/08

(52) U.S. Cl. CPC H01M 8/0656; H01M 12/08

(57) ABSTRACT

A method of generating power with a fuel cell is provided. The method includes charging a metal-air battery. The method also includes generating oxygen during the charging of the metal-air battery. The method further includes collecting the generated oxygen via an air duct. The method includes directing the collected oxygen away from the metal-air battery, via the air duct and into a fuel cell. The method also includes controlling a flow of the oxygen through the air duct using a controlling unit. The method further includes using the oxygen as fuel by the fuel cell. The method includes generating power with the fuel cell.

### TECHNICAL FIELD

The present disclosure relates to a power generation system and more particularly to a method of generating power with a fuel cell.

### BACKGROUND

Environmental concerns associated with conventional sources of energy, such as coal, oil, gasoline, and the like, have resulted in utilization of alternative sources, such as fuel cells, and metal-air batteries for supplying power to various systems and processes in real/later time. The fuel cells and the metal-air batteries as power generating sources are low producers of harmful pollution and also allow clean and efficient production of electricity. Due to their ability to operate using renewable fuel, use of the fuel cells and the metal-air batteries as primary and/or backup power supplies is becoming increasingly prevalent.

U.S. Pat. No. 6,106,963 discloses a fuel cell system which is equipped with an oxygen enrichment unit that supplies oxygen-enriched air to the fuel cell systems. The oxygen enrichment unit is a magnetic oxygen enrichment device that effects oxygen enrichment utilizing the fact that the oxygen molecule is paramagnetic and when magnetized, migrates toward a magnetic pole side. The enrichment unit utilizes an electromagnet and compressed air generated by the compressor unit to generate oxygen enriched air which is supplied to the fuel cells.

### SUMMARY OF THE DISCLOSURE

In one aspect of the present disclosure, a method of generating power with a fuel cell is provided. The method includes charging a metal-air battery. The method also includes generating oxygen during the charging of the metal-air battery. The method further includes collecting the generated oxygen via an air duct. The method includes directing the collected oxygen away from the metal-air battery, via the air duct and into a fuel cell. The method also includes controlling a flow of the oxygen through the air duct using a controlling unit. The method further includes using the oxygen as fuel by the fuel cell. The method includes generating power with the fuel cell.

Other features and aspects of this disclosure will be apparent from the following description and the accompanying drawings.

### BRIEF DESCRIPTION OF THE DRAWINGS

FIG. 1 is a block diagram of an exemplary power generation system, according to one embodiment of the present disclosure;

FIG. 2 is a schematic view of an exemplary fuel cell, according to one embodiment of the present disclosure;

FIG. 3 is a schematic view of an exemplary metal air battery, according to one embodiment of the present disclosure;

FIG. 4 is a block diagram of an exemplary application in which the power generation system of FIG. 1 may be implemented; and

FIG. 5 is a flowchart for a method of generating power with the fuel cell.

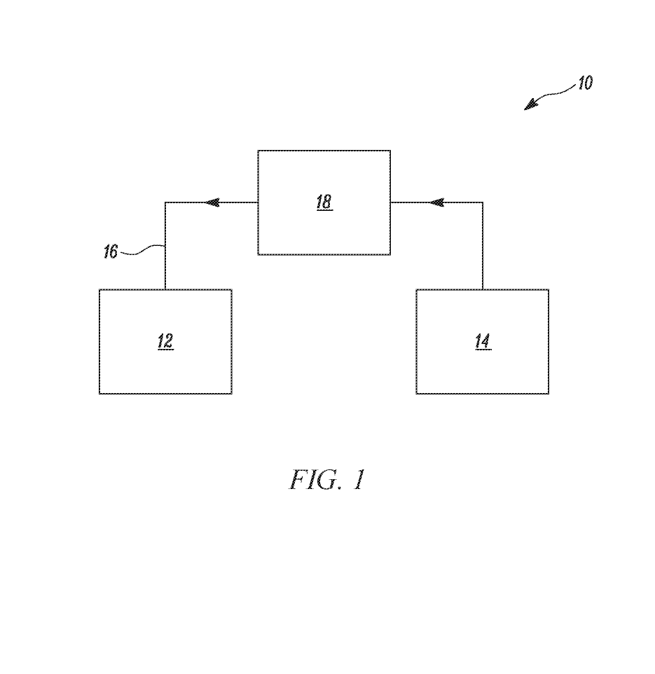

### DETAILED DESCRIPTION

Wherever possible, the same reference numbers will be used throughout the drawings to refer to the same or the like parts. A schematic block diagram of an exemplary power generation system 10 is depicted in FIG. 1. The power generation system 10 may be used in a variety of applications such as, portable power generation, stationary power generation, and power for transportation.

Referring to FIG. 1, the power generation system 10 includes a fuel cell 12 that generates power. The power generation system 10 further includes a metal-air battery 14. The fuel cell 12 and the metal-air battery 14 are connected using an air duct 16.

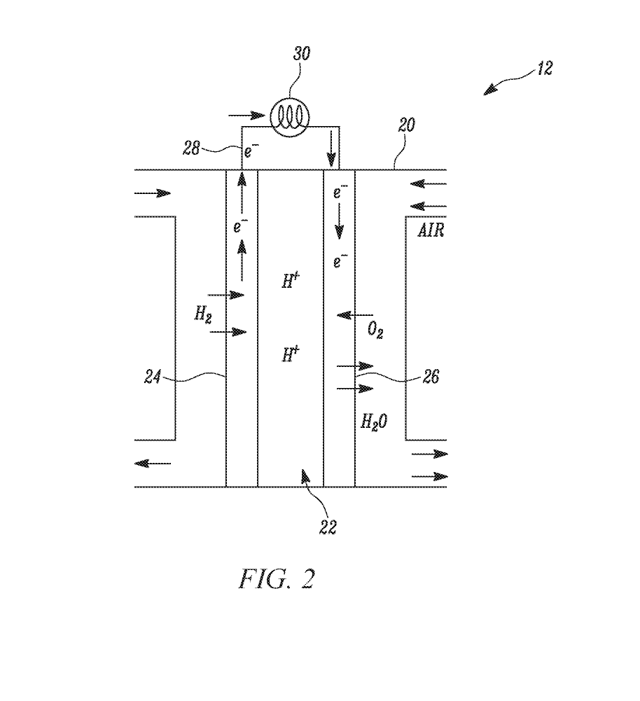

The fuel cell 12 of the power generation system 10 generates electric current based on chemical reactions that occur at the fuel cell 12. Referring to FIG. 2, a schematic view of an exemplary fuel cell 12 is shown. The fuel cell 12 is embodied as a hydrogen fuel cell. The fuel cell 12 includes an electrolyte chamber 20. In one example, the fuel cell 12 may be embodied as an alkaline fuel cell. An electrolyte 22, such as, potassium hydroxide or sodium hydroxide is present within the electrolyte chamber 20 of the fuel cell 12. The fuel cell 12 also includes a cathode 24. Further, an anode 26 is provided in a spaced apart relationship from the cathode 24. The cathode 24 and the anode 26 are positioned within the electrolyte chamber 20, and are at least in partial contact with the electrolyte 22. The cathode 24 and the anode 26 include a porous carbon electrode impregnated with a suitable catalyst such as platinum, silver, cobalt oxide, etc. Usage of the catalytic material for the cathode 24 and the anode 26 causes fuel and oxygen to chemically react at a sufficiently high rate to produce electrical current.

The fuel is fed to the anode 26 of the fuel cell 12. In the illustrated example, the fuel of the fuel cell 12 is hydrogen. In one example, the hydrogen may be extracted from any one of methane, hydrazine, and organic compounds such as formaldehyde, ethanol, methanol, propylene, or other compounds known in the art. When the fuel is introduced in the anode 26, the hydrogen reacts with the catalytic surface of the anode 26 that is in contact with the electrolyte 22 to liberate H⁺ ions and electrons.

Further, oxygen is fed to the cathode 24 of the fuel cell 12. The oxygen fed to the cathode 24 may include oxygen that may be stored and retrieved from commercially available containers, based on system requirements. In another example, the oxygen may be extracted from ambient air. It should be noted that a performance of the fuel cell 12 depends on various factors, one of which may include a partial pressure of the oxygen at the cathode 24. More particularly, an increase in the partial pressure of the oxygen causes an increase in the overall cell voltage.

The oxygen introduced at the cathode 24 reacts with the catalytic surface of the cathode 24 that is in contact with the electrolyte 22. Based on the reaction, the oxygen is reduced to hydroxyl ions by consuming the electrons that are liberated at the anode 26, received via an external electrical path. It may be contemplated that the electrons generated at the anode 26 are conducted to the cathode 24 through a conductor 28 that is provided between the cathode 24 and the anode 26. A transfer of the electrons to the cathode 24 generates the electrical current which can be supplied to an external load 30 connected to the fuel cell 12.

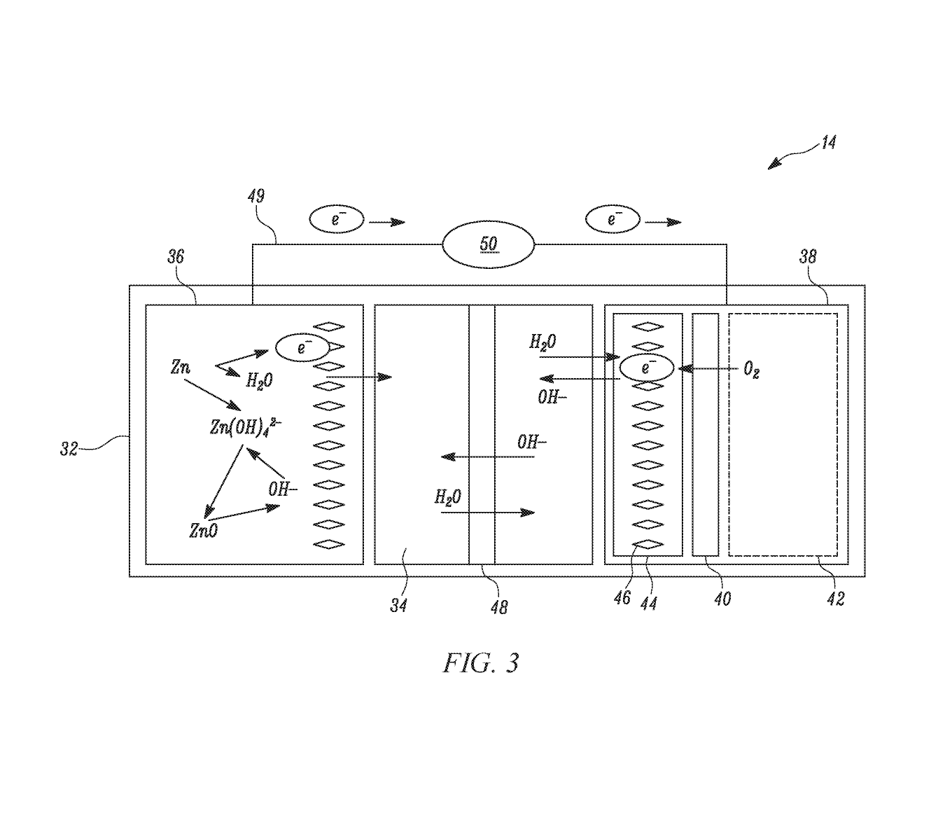

The metal-air battery 14 of the power generation system 10 is embodied as a rechargeable battery that is capable of storing and producing power. More particularly, the metal-air battery 14 produces direct electric current. When connected to an external load 50, the electric current stored in the metal-air battery 14 is supplied to the external load 50 as shown in FIG. 3. Further, when the electric current stored in the metal-air battery 14 reduces, the metal-air battery 14 may be charged to meet electric current requirements of the external load 50. The metal-air battery 14 can be charged by electrically connecting the metal-air battery 14 to a charging station (not shown). The metal-air battery 14 disclosed herein is a zinc-air battery. In other examples, the metal-air battery 14 may use other metals in place of the zinc, including, but not limited to, lithium (Li), calcium (Ca), magnesium (Mg), aluminum (Al), cadmium (Cd), and/or a metal hydride.

Referring to FIG. 3, the metal-air battery 14 includes an electrolyte chamber 32. An electrolyte 34 is present within the electrolyte chamber 32 of the metal-air battery 14. The electrolyte 34 may include a solution of any one of potassium hydroxide, sodium hydroxide, lithium hydroxide, salt water, other salt-based solutions or any hydroxyl ion-conducting media known in the art. The metal-air battery 14 includes a metal electrode 36. In one example, the metal electrode 36 is a made of zinc. The metal electrode 36 is hereinafter interchangeably referred to as the anode 36. Further, the metal-air battery 14 includes a cathode 38. The anode 36 and the cathode 38 are immersed in the electrolyte 34, such that the electrolyte 34 transports hydroxyl ions from the cathode 38 to the anode 36 during a discharge cycle of the metal-air battery 14, and transports the hydroxyl ions from the anode 36 to the cathode 38 during a charge cycle of the metal-air battery 14.

The cathode 38 includes a gas diffusion layer 40, an air permeable membrane 42, and an active layer 44. The gas diffusion layer 40 is disposed between the active layer 44 and the air permeable membrane 42. The gas diffusion layer 40 is porous and hydrophobic, such that the gas diffusion layer 40 allows oxygen from the air to flow through pores of the gas diffusion layer 40 while preventing the electrolyte 34 to flow there through. Further, the air permeable membrane 42 of the cathode 38 includes a porous carbon structure or a metal mesh covered with a catalyst (not shown). The catalyst is selected such that the catalyst has a high affinity for oxygen. The air permeable membrane 42 traps the oxygen presents in the surrounding ambient air and introduces the same in the electrolyte chamber 32.

The active layer 44 of the cathode 38 is provided between the anode 36 and the gas diffusion layer 40 of the cathode 38. The active layer 44 has a double pore structure that includes both hydrophobic and hydrophilic pores. The hydrophobic pores help in achieving high rates of oxygen diffusion, while the hydrophilic pores allow sufficient electrolyte 34 penetrations. The active layer 44 includes a current collector 46. The current collector 46 may be disposed on the active layer 44. In another example, the current collector 46 may be disposed between the gas diffusion layer 40 and the active layer 44. The current collector 46 may be formed of any suitable electrically-conductive material known in the art. For example, the current collector 46 may include a foam current collector. The cathode 38 may further include other layers (not shown), such as a gas selective membrane. Although the metal-air battery 14 disclosed herein includes a single cathode 38, it may be contemplated that the metal-air battery 14 may include multiple cathodes 38, without any limitations.

The metal-air battery 14 includes a separator 48 disposed between the anode 36 and the cathode 38. The separator 48 prevents short circuiting of the metal-air battery 14. The separator 48 is embodied as a thin and porous film, or membrane formed of a polymeric material. The separator 48 may include a material such as polypropylene or polyethylene. The material of the separator 48 may be treated to develop hydrophilic pores that are filled with the electrolyte 34. In other examples, the separator 48 may be made of any material that prevents short circuiting of the metal-air battery 14. In some examples, the metal-air battery 14 may omit the separator 48, without any limitations. It should be noted that the arrangement of the different layers of the cathode 38 disclosed herein is exemplary in nature. Accordingly, the cathode 38 may include a different layering scheme, without limiting the scope of the present disclosure.

During the discharge cycle of the metal-air battery 14, zinc metal present at the anode 36 gets saturated by the electrolyte 34 causing liberation of electrons and formation of zinc ions. Simultaneously, the oxygen that is introduced at the cathode 38 reacts with the catalytic surface of the cathode 38 which is in contact with the electrolyte 34. Based on the reactions, the oxygen is reduced to hydroxyl ions by consuming the electrons that are liberated at the anode 36. The electrons liberated at the anode 36 are conducted to the cathode 38 through a conductor 49 that is provided between the cathode 38 and the anode 36. A transfer of the electrons to the cathode 38 generates the electrical current which can be supplied to the external load 50 connected to the metal-air battery 14. Further, the reaction at the anode 36 and the cathode 38 of the metal-air battery 14 causes formation of zinc oxide in the electrolyte 34. Further, during the charge cycle of the metal-air battery 14, the zinc oxide produced during the discharge cycle is converted back to zinc metal. The zinc metal so formed may get deposited on the anode 36. Additionally, the conversion of the zinc oxide to the zinc metal liberates oxygen at the cathode 38 as a by-product of the chemical reaction. The oxygen liberated by the metal-air battery 14 is generally let out in the atmosphere.

According to one aspect of the present disclosure, the oxygen liberated at the metal-air battery 14 is collected and directed towards the fuel cell 12 to increase the partial pressure of oxygen at the cathode 24 of the fuel cell 12. For this purpose, the power generation system 10 includes the air duct 16. The air duct 16 collects the oxygen generated during the charging of the metal-air battery 14. Further, the air duct 16 directs the collected oxygen away from the metal-air battery 14, via the air duct 16 and into the fuel cell 12. The air duct 16 may include any one of a pipe, tube, channel, conduit, or other fluid conveying means known in the art.

In one example, the power generation system 10 may include a controlling unit 18 (shown in FIG. 1). The controlling unit 18 may be embodied as a valve element. The controlling unit 18 may be adapted to control a flow of the oxygen from the metal-air battery 14 to the fuel cell 12. The controlling unit 18 may provide a control action based on signals received from an actuation module (not shown). The actuation module may be communicably coupled to the controlling unit 18.

Further, one or more sensors (not shown) may be associated with each of the fuel cell 12 and the metal-air battery 14. The sensors may determine an amount of electric current that is available in the fuel cell 12 and the metal-air battery 14 respectively. The actuation module may be communicably coupled to the sensors. Further, the actuation module may receive signals corresponding to the amount of electric current available in the fuel cell 12 and the metal-air battery 14 from the sensors. The actuation module may also receive data corresponding to the electric current requirement of an external load (not shown). Based on the data corresponding to the amount of electric current available in the fuel cell 12 and the metal-air battery 14 and the electric current requirement of the external load (not shown), the actuating module may estimate an additional amount of oxygen required to be introduced in the fuel cell 12. Based on the determination, the actuation module may control the valve element of the controlling unit 18 to meter the flow of the oxygen to the fuel cell 12, via the air duct 16.

### INDUSTRIAL APPLICABILITY

The present disclosure relates to the power generation system 10. The power generation system 10 allows controlled delivery of the oxygen generated during charging of the metal-air battery 14 to the fuel cell 12, for oxygen enrichment purposes. The oxygen generated as a by-product or waste product at the metal-air battery 14 can be utilized more effectively to improve the performance of the fuel cell 12 instead of venting the oxygen to the atmosphere. Further, the additional amount of oxygen that is provided to the fuel cell 12 increases the partial pressure of the oxygen which in turn leads to an overall increase in the cell voltage of the fuel cells 12. Further, the power generation system 10 disclosed herein does not include costly components for introduction of the oxygen that is utilized for oxygen enrichment in the fuel cell 12. Further, the power generated by the power generation system 10 may be supplied and stored via a micro-grid, or any other conventional grid systems. The micro grid 52 may in turn, supply power to a number of external loads associated with industrial, commercial, or residential applications

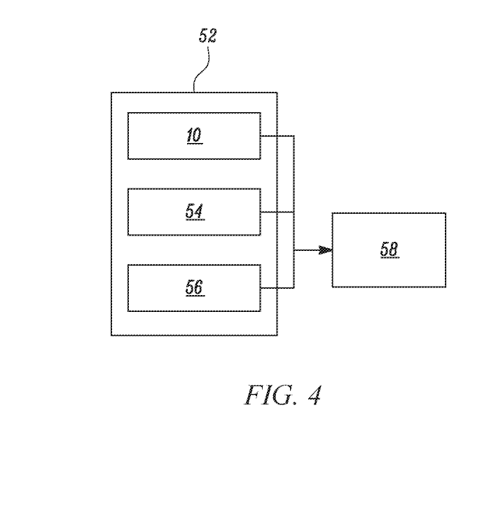

FIG. 4 is a block diagram of an exemplary application in which the power generation system 10 may be implemented. As shown, a micro grid 52 includes the power generation system 10, a photo-voltaic unit 54, and a wind power unit 56. Each of the power generation system 10, the photo-voltaic unit 54, and the wind power unit 56 provides energy to the external load 58. The micro grid 52 may be employed in a variety of applications. For example, the micro grid 52 may be employed on islands, remote mining sites, remote villages, military bases, ships, residential neighborhoods, group of buildings or any other site that is off-grid or not connected to a public utility line or where power efficiency and independence is desired. The power generation system 10 disclosed herein allows cost saving in micro grid applications.

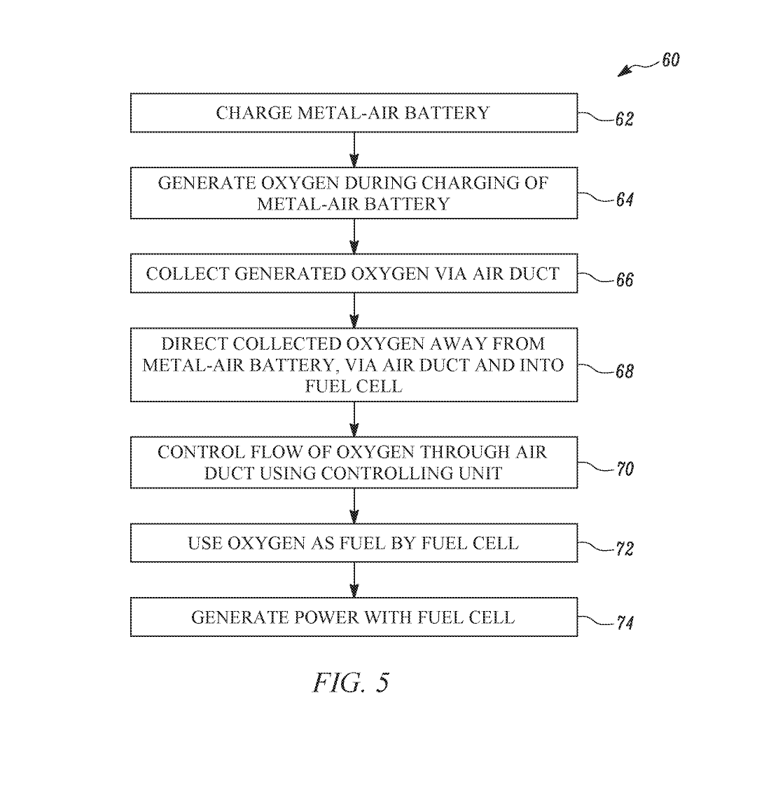

Referring to FIG. 5, a flowchart for a method 60 for generating power with the fuel cell 12 is illustrated. At step 62, the metal-air battery 14 is charged by electrically connecting the metal-air battery 14 to the charging station (not shown). At step 64, the oxygen is generated during the charging of the metal-air battery 14. At step 66, the generated oxygen is collected via the air duct 16. At step 68, the collected oxygen is directed away from the metal-air battery 14, via the air duct 16 and into the fuel cell 12. At step 70, the flow of the oxygen through the air duct 16 is controlled. In one example, the flow of the oxygen may be controlled by the valve element of the controlling unit 18. At step 72, the oxygen is used as a fuel by the fuel cell 12. At step 74, the power is generated with the fuel cell 12 using the oxygen generated at the metal-air battery 14. More particularly, the oxygen generated at the metal-air battery 14 is provided as an additional fuel to the fuel cell 12 in order to improve the performance of the fuel cell 12.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method of generating power with a fuel cell, the method comprising:
charging a metal-air battery;
generating oxygen during the charging of the metal-air battery;
collecting the generated oxygen via an air duct;
directing the collected oxygen away from the metal-air battery, via the air duct and into the fuel cell;
controlling a flow of the oxygen through the air duct using a controlling unit;
using the oxygen as fuel by the fuel cell; and
generating power with the fuel cell.
